(19) United States
(12) Patent Application Publication
(10) Pub. No.: US 2015/0074019 A1
(43) Pub. Date: Mar. 12, 2015

(54) HEALTH GUIDANCE RECEIVER SELECTION CONDITION GENERATION SUPPORT DEVICE

(71) Applicant: NEC Corporation, Tokyo (JP)

(72) Inventors: Yuki Kosaka, Tokyo (JP); Masataka Andou, Tokyo (JP); Ryohei Fujimaki, Tokyo (JP)

(21) Appl. No.: 14/002,550

(22) PCT Filed: Apr. 3, 2013
(86) PCT No.: PCT/JP2013/002301

§ 371 Date: Aug. 30, 2013

(30) Foreign Application Priority Data
Apr. 26, 2012 (JP) 2012-100937

(51) Int. Cl. G06F 19/00; G06N 99/00

(52) U.S. Cl. CPC G06F 19/345; G06N 99/005
USPC 706/12

(57) ABSTRACT

A memory that stores health checkup data of a person and a label value representing whether or not the person fell under a predetermined health guidance criterion in the subsequent period, and a processor connected with the memory are provided. The processor learns a discriminant model with use of the health checkup data of each person and the label value. The discriminant model, in which health checkup items of the health checkup data are used as explanatory variables, is represented as a polynomial including the explanatory variables and coefficients of the respective explanatory variables, and is used for discriminating whether or not the person falls under the health guidance criterion in the subsequent period. The processor generates, as a selection condition, combinations of the health checkup items as the explanatory variables and values of the coefficients in the discriminant model after learning.

### TECHNICAL FIELD

The present invention relates to health guidance service of a health insurer, and in particular, to a device for supporting an operation of a health insurer to determine conditions for selecting health guidance receivers.

### BACKGROUND ART

In recent years, as an increase in medical costs borne by a health insurer for the insured persons puts pressure on the finance of the health insurer, there is an urgent need to formulate measures to reduce the medical costs. As one of the measures, a health insurer gives health guidance to improve the health of the insured persons. Specifically, a health insurer sets certain criteria regarding health checkup results of the insured persons, and gives health guidance to those satisfying the criteria (relevant persons). For example, the criteria are set such that persons who need to improve lifestyles or who have high illness risks in the future fall under the criteria. On the other hand, regarding persons who do not satisfy the criteria (non-relevant persons), it is determined that they do not have to improve lifestyles, whereby the health insurer does not give health guidance.

From April, 2008, health insurers (national health insurance and employee's health insurance) are obliged to provide health checkup and health guidance services to the insured persons and their dependents aged 40 and over, focusing on obesity caused by visceral fat. The health guidance criteria used in the services are stipulated by the Ministry of Health, Labor and Welfare.

However, as characteristics of the insured persons differ depending on the health insurers, if the health guidance receivers are narrowed under uniform conditions, a significant difference may be caused in the effects. As such, it is considered to be desirable to set criteria by the respective health insurers independently besides the health guidance receivers defined by the government, and to give health guidance to the insured persons who meet the criteria.

In particular, the problem is how to cope with those who newly fall under the health guidance criteria. Some persons who do not satisfy the health guidance criteria current year (non-relevant persons) may satisfy the health guidance criteria next year and become relevant persons. As such, even if a health insurer gives health guidance to the relevant persons of the current year so as to improve their health, if the number of relevant persons increases year by year, health improvements in the entire insured persons cannot be achieved.

While it is desirable that a health insurer gives health improvement measures to all of the insured persons in order to improve the health of all of them, it takes enormous costs. As such, health insurers wish to set criteria of their own besides the health guidance criteria, and from among the insured persons of the current year, select those who may fall under the criteria next year, and give health guidance to the selected limited group current year in order that they do not fall under the criteria next year.

Patent Document 1 discloses an exemplary technique of selecting health guidance receivers. The technique disclosed in Patent Document 1 provides a function of outputting predicted values of a medical cost reduction effect if a health insurer sets conditions for selecting receivers and give guidance to a group of the health guidance receivers satisfying such conditions. By using this support system, the health insurer is able to know a medical cost reduction effect in the case of setting particular selection conditions.

Patent Document 1: JP 2007-257565 A

### SUMMARY

However, a method of selecting a group in which a medical cost reduction effect can be achieved by giving health guidance, as described in Patent Document 1, has a possibility of selecting, from non-relevant persons, those who do not fall under the criteria next year actually, based on an assumption that a medical cost reduction effect due to health guidance may be high. As such, it is not always the case that those who fall under the criteria next year are selected.

An object of the present invention is to provide a health guidance receiver selection condition generation support device which solves the above-described problem, that is, a problem that it is difficult to generate conditions for selecting health guidance receivers from the viewpoint of whether or not they have a possibility of falling under the health guidance criteria next year.

A health guidance receiver selection condition generation support device, according to a first aspect of the present invention, is configured to include

a memory that stores first health checkup data which is health checkup data of a person of a first period, and a label value representing whether or not the person fell under a predetermined health guidance criterion according to health checkup data of the person of a second period which is the subsequent period of the first period; and

a processor connected with the memory, wherein

the processor is programmed to

learn a discriminant model with use of the first health checkup data and the label value, the discriminant model being a model in which a plurality of health checkup items of the health checkup data are used as a plurality of explanatory variables, being represented as a polynomial including the explanatory variables and coefficients of the respective explanatory variables, and being used for discriminating whether or not the person falls under the health guidance criterion according to the health checkup data of the second period, and

generate, as a health guidance receiver selection condition, combinations of the health checkup items as the explanatory variables and values of the coefficients in the discriminant model after learning.

Further, a health guidance receiver selection condition generation supporting method, according to a second aspect of the present invention, is a health guidance receiver selection condition generation supporting method to be implemented by a device including a memory that stores first health checkup data which is health checkup data of a person of a first period, and a label value representing whether or not the person fell under a predetermined health guidance criterion according to health checkup data of the person of a second period which is the subsequent period of the first period; and a processor connected with the memory. The method includes, by the processor,

learning a discriminant model with use of the first health checkup data and the label value, the discriminant model being a model in which a plurality of health checkup items of the health checkup data are used as a plurality of explanatory variables, being represented as a polynomial including the explanatory variables and coefficients of the respective explanatory variables, and being used for discriminating whether or not the person falls under the health guidance criterion according to the health checkup data of the second period, and

generating, as a health guidance receiver selection condition, combinations of the health checkup items as the explanatory variables and values of the coefficients in the discriminant model after learning.

As the present invention has the above-described configuration, a health insurer is able to generate conditions for selecting health guidance receivers from the viewpoint of whether or not they have a possibility of falling under the health guidance criteria in the next period.

### BRIEF DESCRIPTION OF DRAWINGS

FIG. 1 is a block diagram showing a first exemplary embodiment of the present invention.

FIG. 2 is a flowchart showing an operation of the first exemplary embodiment of the present invention.

FIG. 3 is a table showing health checkup items corresponding to values of W* which maximize an objective function given by Expression 3 in the first exemplary embodiment of the present invention.

FIG. 4 shows the graph Laplacian and the normalized graph Laplacian for explaining an operation in the first exemplary embodiment of the present invention.

FIG. 5 is a table showing health checkup items corresponding to values of W* which maximize an objective function given by Expression 4 in the first exemplary embodiment of the present invention.

FIG. 6 is a table showing examples of selection conditions generated in the first exemplary embodiment of the present invention.

FIG. 7 is a block diagram showing a second exemplary embodiment of the present invention.

FIG. 8 is a flowchart showing an operation of the second exemplary embodiment of the present invention.

### EXEMPLARY EMBODIMENTS

Next, exemplary embodiments of the present invention will be described with reference to the drawings.

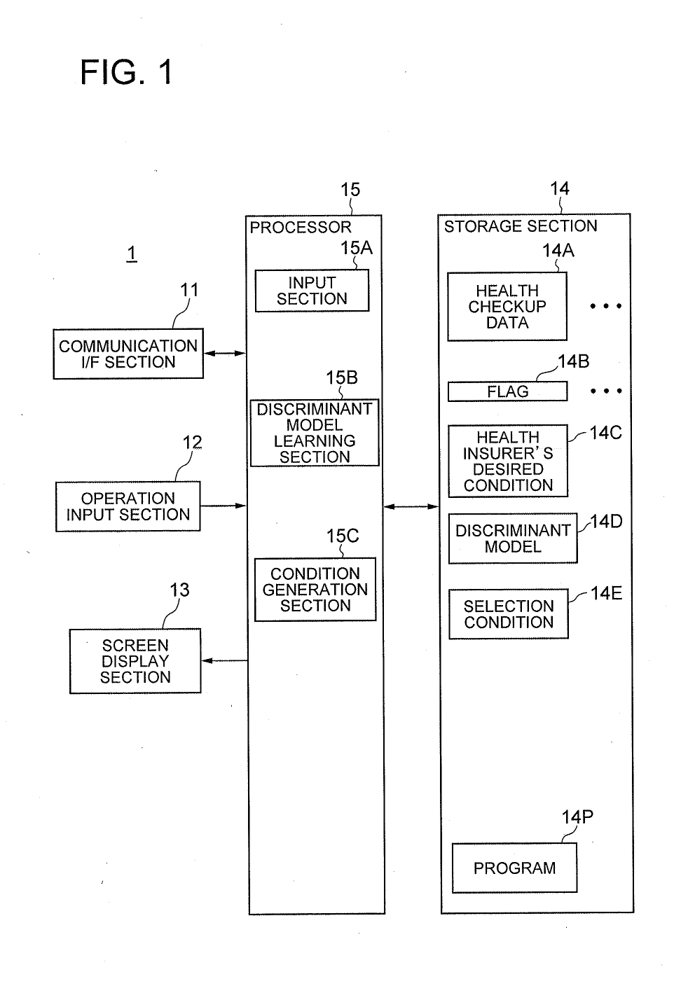

Referring to FIG. 1, a health guidance receiver selection condition generation support device 1 according to a first exemplary embodiment of the present invention has a function of generating conditions for selecting health guidance receivers from the viewpoint of whether or not they have a possibility of falling under the health guidance criteria.

The health guidance receiver selection condition generation support device 1 includes, as hardware, a communication interface section (communication I/F section) 11, an operation input section 12, a screen display section 13, a storage section 14, and a processor 15.

The communication I/F section 11 is configured of a dedicated data communication circuit, and has a function of performing data communications with various types of devices, not shown, connected over communication networks (not shown). The operation input section 12 is configured of operation input devices such as a keyboard and a mouse, and has a function of detecting operations by an operator and outputting them to the processor 15. The screen display section 13 is configured of a screen display device such as an LCD or a PDP, and has a function of displaying, on the screen, various types of information such as operation menu and selection conditions in accordance with instructions from the processor 15.

The storage section 14 is configured of a storage device such as a hard disk or a semiconductor memory, and has a function of storing processing information and a program 14P necessary for various types of processing performed in the processor 15. The program 14P is a program which is read and implemented by the processor 15 to thereby realize various processing sections. The program 14P is read, in advance, from an external device (not shown) or a computer-readable medium (not shown) via a data input/output function of the communication I/F section 11 or the like, and is stored in the storage section 14. Processing information to be stored in the storage section 14 mainly includes health checkup data 14A, a flag 14B, a health insurer's desired condition 14C, a discriminant model 14D, and selection conditions 14E.

The health checkup data 14A is personal health checkup data in a past given year (hereinafter referred to as a base year). The health checkup data 14A is personally managed. Health checkup data of one person in one year includes personal information such as a personal ID which uniquely identifies the person, visit year, visit age, sex, and the like, various test values such as height, weight, abdominal girth, BMI value, minimum blood pressure, maximum blood pressure, blood sugar level, neutral fat, and the like, and results of various medical interviews such as whether or not the person falls under an item that “the amount of alcohol intake per day is 500 ml or more”. While one year is one term in the present embodiment, any term less than one year is acceptable.

The flag 14B is a personal label value showing whether or not a person fell under a given health guidance criterion according to the health checkup of the next year of the base year. A given health guidance criteria is, for example, a health guidance criterion focusing on obesity caused by visceral fat. However, the present invention is not limited to such an example.

The health insurer's desired condition 14C is a condition relating to a person whom the health insurer wishes to actively participate in health guidance. For example, a condition that the health insurer wishes a person in the age of forties to actively participate in health guidance, a condition that the health insurer wishes a person whose result of a particular test item in the health checkup satisfies a given condition, or the like.

The discriminant model 14D is a model showing a relation between personal health checkup data and whether or not the person falls under a given health guidance criterion next year of the base year. The discriminant model 14D may be a linear regression model or a logistic regression model. The discriminant model 14D is generally a polynomial consisting of a plurality of explanatory variables and their coefficients (parameters). As respective explanatory variables, respective health checkup items in the health checkup data are used. All of the health checkup items in the health checkup data may be used as explanatory variables, or part of the health checkup items in the health checkup data may be used as explanatory variables. For example, if health checkup data includes 11 items in total, namely visit age, sex, height, weight, abdominal girth, a BMI value, minimum blood pressure, maximum blood pressure, blood sugar level, neutral fat, and a result of a medical interview of whether or not the person falls under “the amount of alcohol intake per day is 500 ml or more”, all of these 11 items may be used as explanatory variables, or 8 health checkup items except for visit age, sex, and height may be used as explanatory variables.

The selection condition 14E is a health guidance receiver selection condition generated from the discriminant model 14C after learning. In the present embodiment, the selection condition 14E is configured of a combination of a health checkup item and its coefficient, and a determination threshold. A combination of a health checkup item and its coefficient means a combination of, from among a plurality of coefficients in the discriminant model 14D after learning, a combination of a coefficient having a non-zero value and a health checkup item as an explanatory variable corresponding to such a coefficient. Further, a determination threshold means a minimum value of the total value of the coefficient values included in the above-described combination, with which it is determined that a probability that a person falls under the health guidance criterion next year of the base year in the discriminant model 14D after learning is a predetermined threshold (e.g., ½) or larger

The processor 15 includes a microprocessor such as a CPU and its peripheral circuitry, and has a function of reading the program 14P from the storage section 14 and executing it to thereby cause the hardware and the program 14P to cooperate with each other so as to realize various processing sections. The main processing sections realized by the processor 15 include an input section 15A, a discriminant model learning section 1 SB, and a condition generation section 15C.

The input section 15A has a function of accepting, from the communication I/F section 11 or the operation input section 12, the health checkup data 14A, the flag 14B, the health insurer's desired condition 14C, and the discriminant model 14D before learning, and storing them in the storage section 14.

The discriminant model learning section 15B has a function of reading, from the storage section 14, the health checkup data 14A, the flag 14B, the health insurer's desired condition 14C, and the discriminant model 14D before learning, learning the discriminant model 14D using the health checkup data 14A, the flag 14B, and the health insurer's desired condition 14C, and storing the discriminant model 14D after the learning in the storage section 14.

When learning the discriminant model 14D, the discriminant model learning section 15B uses, among pieces of the health checkup data 14A, health checkup data of a person who fell under the health guidance criterion next year as a positive example, and uses health checkup data of a person who did not fall under the health guidance criterion next year as a negative example.

Further, when learning the discriminant model 14D, the discriminant model learning section 15B studies the coefficients of the discriminant model 14D for optimizing an objective function including a term representing the likelihood of a discriminant model, a penalty term depending on the number of coefficients having non-zero values, and a penalty term depending on it that a person not satisfying the health insurer's desired condition falls under the health guidance criterion next year.

The condition generation section 15C has a function of reading the discriminant model 14D after the learning from the storage section 14, generating a combination of a coefficient having a non-zero value and a health checkup item as an explanatory variable corresponding to such a coefficient in the discriminant model 14D after the learning, and the above-described threshold, as the selection condition 14E, and storing it in the storage section 14. The condition generation section 15C also has a function of reading the selection condition 14D from the storage section 14, and outputting it to the screen display section 13 or to the outside via the communication I/F section 11.

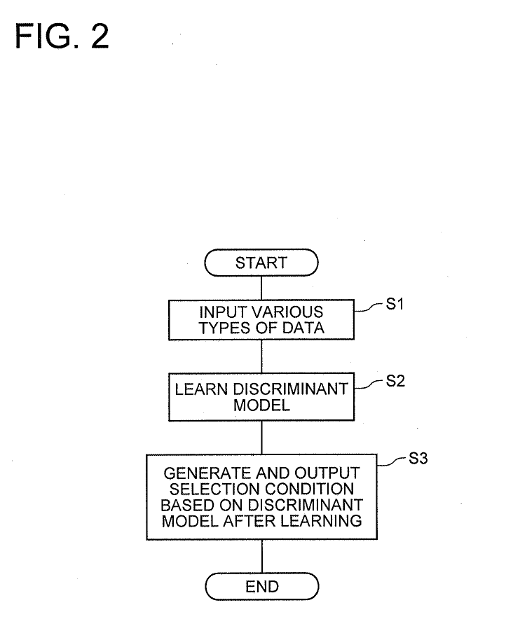

Next, referring to FIG. 2, operation of the health guidance receiver selection support device 1 according to the present embodiment will be described.

First, the input section 15A accepts the health checkup data 14A, the flag 14B, the health insurer's desired condition 14C, and the discriminant model 14D before learning, from the communication I/F section 11 or the operation input section 12, and stores them in the storage section 14 (step S1).

Next, the discriminant model learning section 15B reads, from the storage section 14, the health checkup data 14A, the flag 14B, the health insurer's desired condition 14C, and the discriminant model 14D before learning, and with use of the health checkup data 14A, the flag 14B, and the health insurer's desired condition 14C, studies the discriminant model 14D (step S2). This means that the discriminant model learning section 15B uses, among pieces of the health checkup data 14A, health checkup data of a person who fell under the health guidance criterion next year as a positive example, and uses health checkup data of a person who did not fall under the health guidance criterion next year as a negative example, and studies the value of each explanatory variable in the discriminant model 14D for correlating personal health checkup data and whether or not the person falls under a predetermined health guidance criterion next year such that the health insurer's desired condition 14 is met as much as possible. The discriminant model 14D after the learning is stored in the storage section 14.

Then, the condition generation section 15C reads the discriminant model 14D after the learning from the storage section 14, and among a plurality of explanatory variables of the discriminant model 14D after the learning, stores, in the storage section 14, a combination of an explanatory variable in which the value of the coefficient thereof is not 0 and a determination threshold, as a selection condition 14E, and outputs it to the screen display section 13 or to the outside via the communication I/F section 11 (step S3).

Next, operation of the present embodiment will be described in more detail. It should be noted that in the following description, a subscript index is represented with an underline. For example, A_{B} is represented as AB. A superscript index is represented with a hut. For example, A^{B} is represented as ÂB.

### (1-1) Details of Step S1

The input section 15A accepts the health checkup data 14A, the flag 14B, the health insurer's desired conditions 14C, and the discriminant model 14D before learning.

The accepted health checkup data is represented as X_n (n=1, 2, . . . , N). N represents the number of persons who are candidates of health guidance receivers. X_n assumes to be health checkup data of a person “n” in the base year. X_nj (j=1, . . . , M) represents a measurement result of a health checkup item “j” of the person n (health checkup item also includes a medical interview result). M represents the number of health checkup items.

In addition, the accepted flag is represented as Y_n (n=1, . . . , N). This means that Y_n is a flag representing whether the person n fell under a given health guidance criterion according to the health checkup next year of the base year (Y_n=1) or not (Y_n=0).

As preprocessing, the input section 15A binarizes health checkup data. The input section 15A sets a threshold for binarization for each of the health checkup items, and based on the threshold, binarizes X_nj (j=1, . . . , M) to 0 or 1. As the threshold for each test item, the health guidance determination criterion defined by the Ministry of Health, Labor and Welfare may be used. For example, a BMI value is binarized to 1 if it is 25 or higher, while in other cases, it is binarized to 0. If the accepted health checkup data has already been binarized, this processing is unnecessary.

### (1-2) Details of Step S2

A value obtained from the discriminant model 14D is P as shown below. The discriminant model learning section 15B uses the discriminant model 14D for calculating this value to learn the parameter.

P(Y_n=1) represents a probability that the person n falls under a given health guidance criterion. A probability that the person n does not fall under a given health guidance criterion is calculated from 1−P(Y_n=1), which is assumed to be P(Y_n=0).

Here, X_n where Y_n=1 is called a positive example, and X_n where Y_n=0 is called a negative example. For example, a logistic regression model, capable of outputting a probability that X_n is a positive example or a negative example, may be used. A logistic regression model is a model which is typically applied to a binary discrimination case which discriminates whether Y_n=1 or Y_n=0 from X_n. Hereinafter, the mathematical structure of logistic regression will be described.

It is assumed that X represents an explanatory variable of M dimension corresponding to health checkup data of the base year, and that Y represents a probability variable representing whether or not the person fell under a given health guidance criteria according to the health checkup data of the next year of the base year (Y=1 indicates relevant, Y=0 indicates non-relevant). If W represents a weight vector of the M dimension, the logistic regression model is represented as follows:

P(Y=1|X;W)=1/(1+exp(Ŵ{T}X)) (1)

P(Y=0|X;W)=1−P(Y=1|X;W) (2)

in which P(|∘;♦) represents a conditioned probability of where ∘ is given, with ♦ being a parameter. Further, superscript T represents transpose of a vector.

If a positive example and a negative example {X_n,Y_n}(n=1, . . . , N) is given as learning data, in the logistic regression, a value of a parameter W is calculated by optimizing the following objective function, where X_n and Y_n are realized values of X and Y, respectively.

L(W)=¥sum̂{N}_{—}{n=1} log P(Y_{—}n|X_{—}n,W) (3)

Here, ¥sum̂{N}_{n=1} represents the sum from n=1 to N.

L(W) is able to be maximized by a method conforming to a gradient method. A value of a parameter W which maximizes L(W) is assumed to be W.

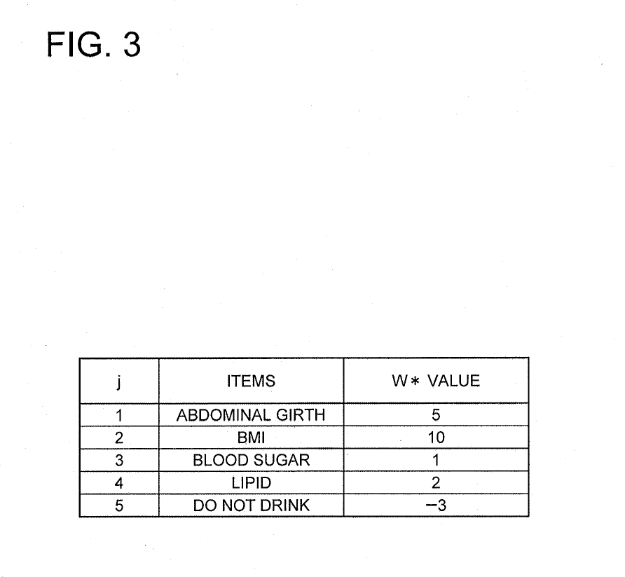

FIG. 3 shows examples of health checkup items corresponding to values of W* which maximize the objective function given by Expression 3. The examples shown in FIG. 3 are exemplary results of obtaining coefficients of the respective explanatory variables which maximize the objective function in which five health checkup items, namely abdominal girth, BMI, blood sugar, lipid, and do not drink alcohol, are used as explanatory variables.

Referring to FIG. 3, the values of the coefficients of all of the five explanatory variables are other than 0. This means that the number of condition items of selection conditions is five. In general, in order to have an insured person participate in health guidance, it is necessary to disclose the grounds for selection from the health insurer to the insured person and obtains an understanding of the insured person. If complicated selection grounds with a large number of condition items are set, it is difficult to obtain an understanding of the insured person. As such, it is desirable that the number of condition items, which serve as selection conditions, is as small as possible. Further, with the objective function of Expression 3, it is impossible to perform optimization in line with the health insurer's desired condition 14C.

As such, the discriminant model learning section 15B studies W* which optimizes the objective function of the following Expression 4, instead of the objective function of Expression 3.

L(W)=¥sum̂{N}_{—}{n=1} log P(Y_{—}n|X_{—}n,W)−(λ/2)*∥W∥−(α/2)F̂{T}L′F (4)

Here, ∥W∥ is a norm of W, and norm 1 is used. F is a N-dimensional vector, and the n^{th} element is represented as Ŵ{T}X_n. L′ represents the normalized graph Laplacian. λ, and α are parameters for adjusting the balance between the first term, the second term, and the third term on the right side.

The first term on the right side of Expression 4 is the same as the right side of Expression 3, which represents likelihood of the discriminant model.

The second term on the right side of Expression 4 is a penalty term which depends on the number of the coefficients having non-zero values. The second term on the right side has an effect of reducing the coefficients of the respective explanatory variables of the discriminant model, that is, the number of explanatory variables in which the element of W* is not 0.

The third term on the right side of Expression 4 is a penalty term which depends on it that a person not satisfying the health insurer's desired condition falls under the health guidance criterion. The third term on the right side has an effect of adjusting the weight of each element of W* so as to meet the health insurer's desired condition. With this third term on the right side, W* is learned so as to satisfy the health insurer's desired condition as much as possible. Thus, by generating conditions by extracting components, the value of which is not 0, of W* after the learning, it is possible to generate health guidance receiver selection conditions in which the number of condition items are less, in line with the health insurer's desired condition.

Hereinafter, the normalized graph Laplacian L′ will be described.

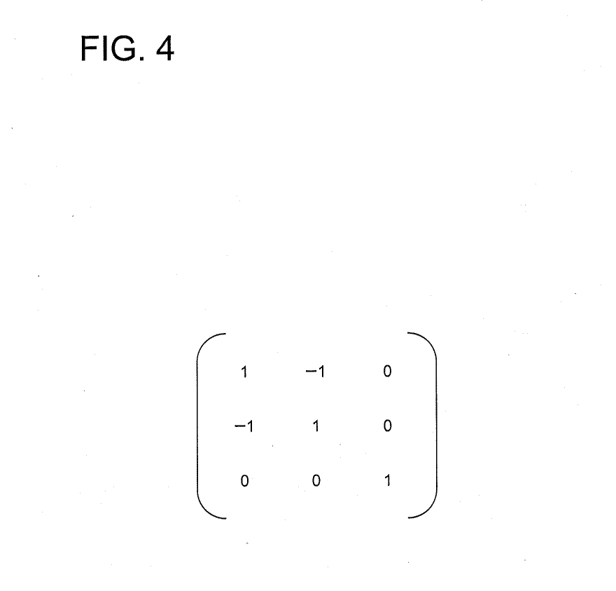

First, the graph Laplacian will be described. The graph Laplacian is a matrix of N*M. N represents the number of persons who are candidates of health guidance receivers. FIG. 4 shows an example of the graph Laplacian where the number of persons N=3 (person 1, person 2, person 3), for the sake of convenience. In this example, the normalized graph Laplacian is the same as graph Laplacian.

In the graph Laplacian and the normalized graph Laplacian in FIG. 4, each of the rows and columns represents a person. The first row in FIG. 4 shows that the person 1 and the person 2 have a link. The second row in FIG. 4 shows that the person 1 and the person 2 have a link. The third row in FIG. 4 shows that there is no link.

In an example in which the health insurer's desired condition 14C is a condition that the health insurer wishes to, have persons in their forties actively participate in health guidance, presence of a link means that the health insurer's desired condition is satisfied. The example of FIG. 4 shows that the person 1 and the person 2 satisfy the health insurer's desired condition (person in his/her forties), and the person 3 does not satisfy the health insurer's desired condition (person in his/her forties). It is also acceptable to store the above-described normalized graph Laplacian L′ itself in the storage section 14 as the health insurer's desired condition 14C to thereby apply it to the objective function of Expression 4. Meanwhile, it is also acceptable to store the condition that the health insurer wishes to have persons in their forties actively participate in health guidance in the storage section 14 as the health insurer's desired condition 14C, and generate the above-described normalized graph Laplacian L′ from such a condition, to thereby apply it to the objective function of Expression 4.

It should be noted that in the case of using the normalized graph Laplacian of FIG. 4, the third term on the right side of Expression 4 is equivalent to the following Expression 5.

−(α/2){(Ŵ{T}X_{—}1−Ŵ{T}X_{—}2)̂2+(Ŵ{T}X_{—}3)̂2} (5)

In order to maximize the objective function of Expression 4, it is necessary to learn W* such that the value of (Ŵ{T}X_{—}3)̂2 according to the person 3 does not satisfy the health insurer's desired condition. Regarding the person 1 and the person 2 satisfying the health insurer's desired condition, it is necessary to learn W* such that the value of Ŵ{T}X becomes the same between the person 1 and the person 2.

While W* is an M dimension vector, the value of a non-zero element, among the respective elements in the M dimension vector, and a health checkup item corresponding to such an element are stored in a set in the storage section 14 as the selection condition 14E. This means that (W*_j, health checkup item j){j|W*_j≠0} is stored in the storage section 14 as the selection condition 14E.

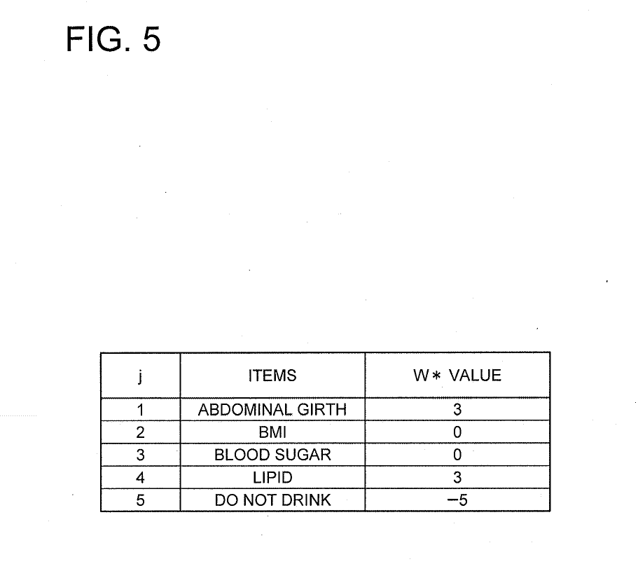

FIG. 5 shows exemplary health checkup items corresponding to the values of W* which maximize the objective function given by Expression 4. The examples shown in FIG. 5 are results of calculating the values of the coefficients of the respective explanatory variables which maximize the object function of FIG. 4 in which five health checkup items, namely abdominal girth, BMI, blood sugar, lipid, and do not drink alcohol, are used as explanatory variables. Referring to FIG. 5, the coefficient values of BMI and blood sugar level are 0, which is different from the case of FIG. 3.

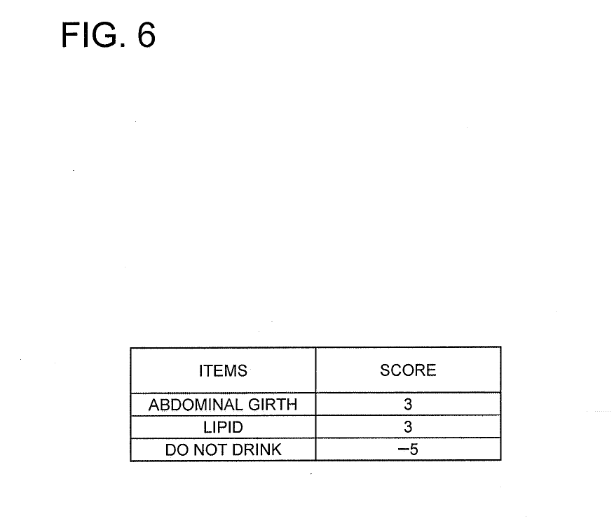

FIG. 6 shows examples of the selection conditions 14E generated by extracting the health checkup items corresponding to non-zero elements and the coefficient values corresponding to the health checkup items from FIG. 5. Referring to FIG. 6, the number of condition items of the selection conditions is reduced from 5 items to 3 items, which is different from the case of FIG. 3. In the example of FIG. 6, the coefficient values are handled as scores.

Further, the value of Ŵ{T}X where P(Y=1|X;W)=TH in Expression 1 is calculated as a determination threshold for determining whether “falling under a given criterion next year” or “not falling under a given criterion next year”, and the value is stored in the storage section 14 as part of the selection condition 14E. TH takes 0.5, for example, but it may take another value.

The condition generation section 15C outputs the condition of (W*_j, health checkup item j){j|W*_j≠0} and the determination threshold, constituting the selection condition 14E, to the screen display section 13 or to the outside from the communication I/F section 11.

As described above, according to the present embodiment, the health insurer is able to generate conditions for selecting health guidance receivers from the viewpoint of whether or not there is a possibility that the receives fall under the health guidance criteria next period. This is because the discriminant model 14D, in which a plurality of health checkup items of the health checkup data are used as explanatory variables, and which is represented by a polynomial configured of the explanatory variables and the coefficients of the respective explanatory variables and is used for discriminating whether or not a person falls under the health guidance criteria according to the health checkup data of the next year of the base year, is learned using the health checkup data 14A of the base year and the flag 14B representing whether each person fell under the health guidance criteria according to the health checkup data of the next year of the base year, and combinations of the health checkup items as the explanatory variables in the discriminant model 14D after the learning and the coefficient values are generated as the selection conditions 14E.

Further, according to the present embodiment, the number of health checkup items as selection conditions can be reduced. This is because in the learning of the discriminant model 14D, the coefficient values of the discriminant model 14D are learned so as to optimize the objective function of Expression 4 having a penalty term depending on the number of coefficients in which the value is not zero.

Further, according to the present embodiment, it is possible to generate selection conditions which meet the health insurer's desired condition. This is because in the learning of the discriminant model 14D, the coefficient values of the discriminant model 14D are learned so as to optimize the objective function represented by Expression 4 having a penalty term depending on it that a person not satisfying the health insurer's desired condition falls under the health guidance criteria.

Further, according to the present embodiment, it is possible to generate a threshold for determining whether or not a person falls under a given criterion near year as a part of the selection conditions 14E. This is because the value of Ŵ{T}X where P(Y=1|X;W)=TH in Expression 1 is calculated, and is stored in the storage section 14 as a part of the selection conditions 14E.

### Second Exemplary Embodiment

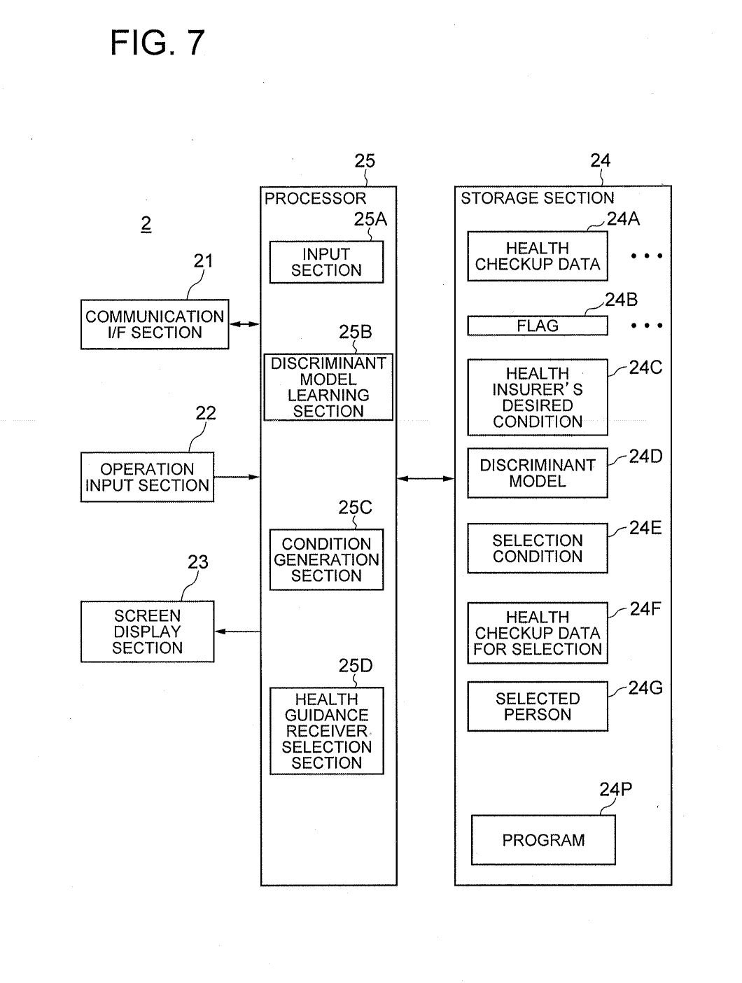

Referring to FIG. 7, a health guidance receiver selection condition generation support device 2 according to a second exemplary embodiment of the present invention has a function of generating conditions for selecting a health guidance receiver from the viewpoint of whether or not he/she falls under the health guidance criteria, and a function of selecting a health guidance receiver in accordance with the generated selection conditions.

The health guidance receiver selection condition generation support device 2 includes, as hardware, a communication interface section (communication I/F section) 21, an operation input section 22, a screen display section 23, a storage section 24, and a processor 25.

The communication I/F section 21, the operation input section 22, and the screen display section 23 have the same functions as those of the communication I/F section 11, the operation input section 12, and the screen display section 13 of the first exemplary embodiment.

The storage section 24 is configured of a storage device such as a hard disk or a semiconductor memory, and has a function of storing processing information and a program 24P necessary for various kinds of processing performed by the processor 25. The program 24P is a program which is read and executed by the processor 25 to thereby realize various processing sections. The program 24P is read, in advance, from an external device (not shown) or a computer-readable medium (not shown) via a data input/output function such as the communication I/F section 21, and is stored in the storage section 24. The processing information to be stored in the storage section 24 mainly includes health checkup data 24A, a flag 24B, a health insurer's desired condition 24C, a discriminant model 24D, a selection condition 24E, health checkup data 24F for selection, and a selected person 24G.

The health checkup data 24A, the flag 24B, the health insurer's desired condition 24C, the discriminant model 24D, and the selection condition 24E are the same as the health checkup data 14A, the flag 14B, the health insurer's desired condition 14C, the discriminant model 14D, and the selection condition 14E of the first exemplary embodiment.

The health checkup data 24F for selection is personal health checkup data in a year in which a health guidance receiver is selected (hereinafter referred to as a selection year). The health checkup data 24A is managed personally. Health checkup data of one person in the current year includes the same items as those of the health checkup data of the base year. As such, the health checkup data 24F of one person includes personal information such as a personal ID which uniquely identifies the person, visit year, visit age, and sex, various test values such as height, weight, abdominal girth, minimum blood pressure, maximum blood pressure, blood sugar level, and neutral fat, and results of various medical interviews such as whether or not the person falls under “the amount of alcohol intake per day is 500 ml or more”. It should be noted that the health checkup data 24F for selection may solely be configured of personal health checkup data of persons not falling under given health guidance criteria. Alternatively, health checkup data of persons falling under the given health guidance criteria and health checkup data of persons not falling under the given health guidance criteria may be mixed.

The selected person 24G is information specifying persons selected as health guidance receivers, that is, a list of personal IDs, for example.

The processor 25 includes a microprocessor such as a CPU and its peripheral circuitry, and has a function of reading the program 24P from the storage section 24 and executing it to thereby allow the hardware and the program 24P to cooperate with each other so as to realize various processing sections. The main processing sections realized by the processor 25 include an input section 25A, a discriminant model learning section 25B, a condition generation section 25C, and a health guidance receiver selection section 25D.

The input section 25A, the discriminant model learning section 25B, and the condition generation section 25C have the same functions as those of the input section 15A, the discriminant model learning section 15B, and the condition generation section 15C of the first exemplary embodiment.

The health guidance receiver selection section 25D has a function′ of reading the selection condition 24E and the health checkup data 24F for selection from the storage section 24, determining, from the health checkup data 24F, a person having health checkup data meeting the selection condition 24E as a health guidance receiver, and storing the person as the selected person 24G in the storage section 24. The health guidance receiver selection section 25D also has a function of reading the selected person 24G from the storage section 24, and outputting the selected person 24G to the screen display section 23 or to the outside via the communication I/F section 21.

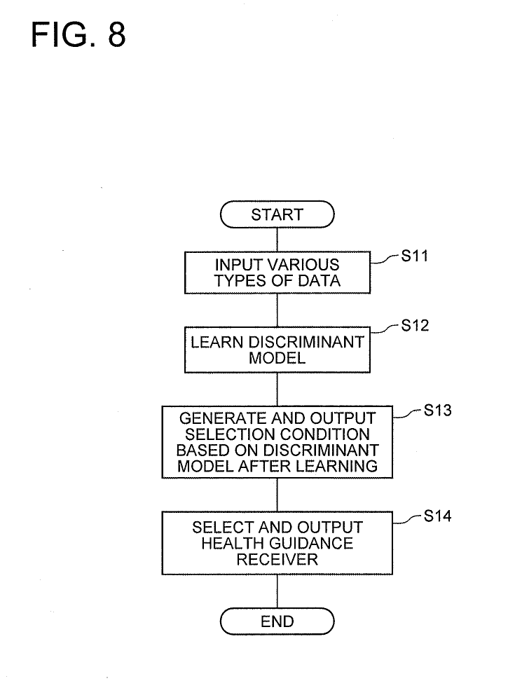

Next, with reference to FIG. 8, operation of the health guidance receiver selection support device 2 of the present embodiment will be described.

First, the input section 25A receives the health checkup data 24A, the flag 24B, the health insurer's desired condition 24C, the discriminant model 24D before learning, and the health checkup data 24F for selection from the communication I/F section 21 or the operation input section 22, and stores them in the storage section 24 (step S11).

Next, the discriminant model learning section 25B reads, from the storage section 24, the health checkup data 24A, the flag 24B, the health insurer's desired condition 24C, and the discriminant model 24D before learning, and with use of the health checkup data 24A, the flag 24B, and the health insurer's desired condition 24C, studies the discriminant model 24D in the same manner as the case of the discriminant model learning section 15B of the first exemplary embodiment (step S12). The discriminant model 24D after the learning is stored in the storage section 24.

Then, the condition generation section 25C reads the discriminant model 24D after the learning from the storage section 24, and in the same manner as the case of the condition generation section 15C of the first exemplary embodiment, among a plurality of explanatory variables of the discriminant model 24D after the learning, generates a combination of a health checkup item in which the value of the coefficient thereof is other than 0 and the coefficient value and a determination threshold thereof as the selection condition 24E, stores them in the storage section 24, and outputs them to the screen display section 23 or to the outside via the communication I/F section 21 (step S 13).

Then, the health guidance receiver selection section 25D reads the selection condition 24E and the health checkup data 24F for selection from the storage section 24, determines, from the health checkup data 24F, a person having health checkup data meeting the selection condition 24E as a health guidance receiver, stores the person as the selected person 24G in the storage section 24, and outputs the selected person 24G to the screen display section 23 or to the outside via the communication I/F section 21 (step S14).

More specifically, the health guidance receiver selection section 25D calculates, for each piece of health checkup data of each person included in the health checkup data 24F for selection, the sum of the scores corresponding to the relevant items among the respective health checkup items in the selection condition 24E. For example, if the selection conditions 24E are those shown in FIG. 6, and if a person falls under the items “abdominal girth” and “lipid” while does not fall under the item “do not drink alcohol”, the personal score is calculated as 3+3=6. Then, the health guidance receiver selection section 25D compares this personal score with the determination threshold in the selection condition 24, and if the personal score>determination threshold, the health guidance receiver selection section 25D selects the person as a health guidance receiver.

As described above, according to the present embodiment, it is possible to achieve the same effect as that of the first exemplary embodiment, and is also possible to select a health guidance receiver from the viewpoint of whether or not a person has a possibility of falling under the health guidance criteria next year.

### Other Exemplary Embodiments

While the present invention has been described with reference to the exemplary embodiments, the present invention is not limited to the above-described embodiments, and additions and modifications thereto can be made in various manners. For example, exemplary embodiments as shown below are also included in the present invention.

While, in the above-described embodiments, selection conditions for a health guidance receiver meeting the health insurer's desired conditions are generated, it is possible to generate selection conditions without considering the health insurer's desired conditions. In that case, an objective function in which the third term on the right side of Expression 4 is omitted may be used.

While, in the above-described embodiments, the health checkup items as selection conditions are set such that the number thereof becomes as small as possible, if there is no need to minimize the number of the items, an objective function in which the second term on the right side of Expression 4 is omitted may be used.

While, in the second exemplary embodiment, a determination threshold is calculated and a person having a score which is the same as the determination threshold or higher is selected as a health guidance receiver, it is possible to select a health guidance receiver without using a determination threshold. For example, it is possible to calculate, for each person, the probability that the person becomes a health guidance receiver next year with use of Expression 1, and select the top N number of persons having higher probabilities as health guidance receivers.

The present invention is based upon and claims the benefit of priority from Japanese patent application No. 2012-100937, filed on Apr. 26, 2012, the disclosure of which is incorporated herein in its entirety by reference.

### REFERENCE NUMERALS

1, 2 health guidance receiver selection condition generation support device
11, 21 communication I/F section
12, 22 operation input section
13, 23 screen display section
14, 24 storage section
15, 25 processor

1. A health guidance receiver selection condition generation support device comprising:
a memory that stores first health checkup data which is health checkup data of a person of a first period, and a label value representing whether or not the person fell under a predetermined health guidance criterion according to health checkup data of the person of a second period which is the subsequent period of the first period; and
a processor connected with the memory, wherein
the processor is programmed to
learn a discriminant model with use of the first health checkup data and the label value, the discriminant model being a model in which a plurality of health checkup items of the health checkup data are used as a plurality of explanatory variables, being represented as a polynomial including the explanatory variables and coefficients of the respective explanatory variables, and being used for discriminating whether or not the person falls under the health guidance criterion according to the health checkup data of the second period, and
generate, as a health guidance receiver selection condition, combinations of the health checkup items as the explanatory variables and values of the coefficients in the discriminant model after learning.

2. The health guidance receiver selection condition generation support device, according to claim 1, wherein
when learning the discriminant model, the processor learns the values of the coefficients of the discriminant model so as to optimize an objective function including a term representing likelihood of the discriminant model and a penalty term depending on the number of coefficients having non-zero values.

3. The health guidance receiver selection condition generation support device, according to claim 1, wherein
the memory further stores a health insurer's desired condition, and
when learning the discriminant model, the processor learns the values of the coefficients of the discriminant model so as to optimize an objective function including a term representing likelihood of the discriminant model, a penalty term depending on the number of the coefficients having non-zero values, and a penalty term depending on it that a person not satisfying the health insurer's desired condition falls under the health guidance criterion.

4. The health guidance receiver selection condition generation support device, according to claim 2, wherein
when generating the health guidance receiver selection condition, the processor generates, as the health guidance receiver selection condition, one or more combinations of one or more coefficients having non-zero values, among the plurality of the coefficients in the discriminant model after learning, and one or more health checkup items as explanatory variables corresponding to the coefficients.

5. The health guidance receiver selection condition generation support device, according to claim 2, wherein
when generating the health guidance receiver selection condition, the processor generates, as the health guidance receiver selection condition, one or more combinations of one or more coefficients having non-zero values, among the plurality of the coefficients in the discriminant model after learning, and one or more health checkup items as explanatory variables corresponding to the coefficients, and a determination threshold, the determination threshold being a minimum value of the total value of the values of the coefficients included in the combinations, and being a threshold with which a probability that the person falls under the health guidance criterion according to the health checkup data of the second period in the discriminant model after learning is determined to be a predetermined value or higher.

6. The health guidance receiver selection condition generation support device, according to claim 1, wherein
the memory further stores second health checkup data which is health checkup data of a person who is a candidate of a health guidance receiver, and
the processor further determines a person meeting the health guidance receiver selection condition based on the second health checkup data.

7. The health guidance receiver selection condition generation support device, according to claim 5, wherein
the memory further stores second health checkup data which is health checkup data of a person who is a candidate of a health guidance receiver, and
the processor further determines a person meeting the health guidance receiver selection condition based on the second health checkup data, and when determining the person meeting the health guidance receiver selection condition, for each piece of the second health checkup data of each person, calculates the sum of scores corresponding to relevant items among the health checkup items in the health guidance receiver selection condition, and compares the sum with the determination threshold.

8. A health guidance receiver selection condition generation supporting method, to be implemented by a device including a memory that stores first health checkup data which is health checkup data of a person of a first period, and a label value representing whether or not the person fell under a predetermined health guidance criterion according to health checkup data of the person of a second period which is the subsequent period of the first period; and a processor connected with the memory, the method comprising:
by the processor,
learning a discriminant model with use of the first health checkup data and the label value, the discriminant model being a model in which a plurality of health checkup items of the health checkup data are used as a plurality of explanatory variables, being represented as a polynomial including the explanatory variables and coefficients of the respective explanatory variables, and being used for discriminating whether or not the person falls under the health guidance criterion according to the health checkup data of the second period; and
generating, as a health guidance receiver selection condition, combinations of the health checkup items as the explanatory variables and values of the coefficients in the discriminant model after learning.

9. A non-transitory computer-readable medium storing a program comprising instructions for causing a processor to perform, the processor being connected with a memory that stores first health checkup data which is health checkup data of a person of a first period, and a label value representing whether or not the person fell under a predetermined health guidance criterion according to health checkup data of the person of a second period which is the subsequent period of the first period:
a step of learning a discriminant model with use of the first health checkup data and the label value, the discriminant model being a model in which a plurality of health checkup items of the health checkup data are used as a plurality of explanatory variables, being represented as a polynomial including the explanatory variables and coefficients of the respective explanatory variables, and being used for discriminating whether or not the person falls under the health guidance criterion according to the health checkup data of the second period; and
a step of generating, as a health guidance receiver selection condition, combinations of the health checkup items as the explanatory variables and values of the coefficients in the discriminant model after learning.
